(19) United States
(12) Patent Application Publication
(10) Pub. No.: US 2020/0150780 A1
(43) Pub. Date: May 14, 2020

(54) INPUT METHOD EDITOR

(71) Applicant: Microsoft Technology Licensing, LLC, Redmond, WA (US)

(72) Inventor: Xianchao Wu, Tokyo (JP)

(21) Appl. No.: 16/492,837

(22) PCT Filed: Apr. 25, 2017
(86) PCT No.: PCT/CN2017/081882

§ 371 Date: Sep. 10, 2019

(51) Int. Cl. G06F 3/023; G06F 3/01; H04L 12/58; G06F 40/274

(52) U.S. Cl. CPC G06F 3/0237; G06F 3/0236; G06F 40/274; H04L 51/02; G06F 3/018

(57) ABSTRACT

The present disclosure provides a method for facilitating information input in a conversation session. An Input Method Editor (IME) interface is presented during the conversation session. One or more candidate messages are provided in the IME interface before a character is input into the IME interface.

### BACKGROUND

Artificial intelligence (AI) conversational chat programs are becoming more and more popular. These conversational chat programs, also referred to as chatbots, allow users to carry on conversations with a virtual entity. An input method editor (IME) enables a user to input text such as words, phrases, sentences and so on in a certain language in a conversation with a chatbot.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure provide a method for facilitating information input in a conversation session. An IME interface is presented during the conversation session. One or more candidate messages are provided in the IME interface before a character is input into the IME interface.

It should be appreciated that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary environment where the described techniques can be implemented according to an embodiment.

FIG. 2 illustrates an exemplary system applying a chatbot according to an embodiment.

FIGS. 3A to 3H each illustrates an exemplary user interface (UI) according to an embodiment.

FIG. 4 illustrates an exemplary process for collecting training data according to an embodiment.

FIGS. 5A and 5C each illustrates an exemplary dependency tree for an example Japanese sentence according to an embodiment.

FIG. 5B and 5D each illustrates an exemplary topic knowledge graph according to an embodiment.

FIG. 6 illustrates an exemplary process for training a classifier for predicting next query type according to an embodiment.

FIG. 7 illustrates an exemplary process for predicting candidate next queries according to an embodiment.

FIG. 8 illustrates an exemplary structure of a part of an IME system according to an embodiment

FIG. 9 illustrates an exemplary process for training user sensitive language models according to an embodiment.

FIG. 10 illustrates an exemplary IME system according to an embodiment.

FIG. 11 illustrates an exemplary process for facilitating information input during a conversation session according to an embodiment.

FIG. 12 illustrates an exemplary process for facilitating information input during a conversation session according to an embodiment.

FIG. 13 illustrates an exemplary apparatus for facilitating information input during a conversation session according to an embodiment.

FIG. 14 illustrates an exemplary computing system according to an embodiment.

### DETAILED DESCRIPTION

The present disclosure will now be discussed with reference to several exemplary implementations. It is to be understood that these implementations are discussed only for enabling those skilled in the art to better understand and thus implement the embodiments of the present disclosure, rather than suggesting any limitations on the scope of the present disclosure.

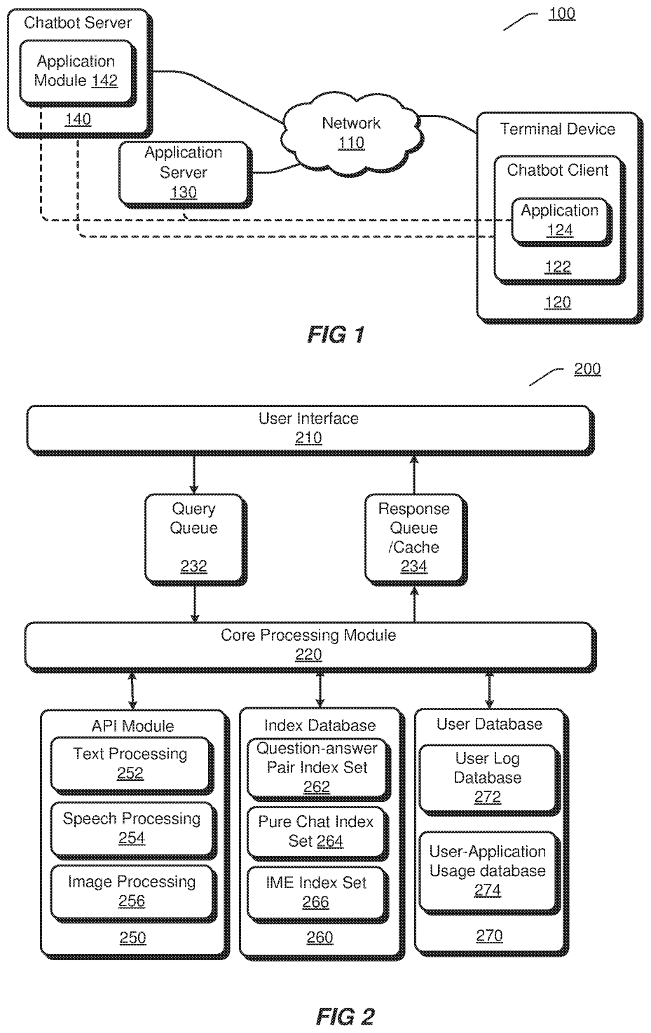

FIG. 1 illustrates an exemplary environment 100 where the described techniques can be implemented according to an embodiment.

In the exemplary environment 100, a network 110 is applied for interconnecting among a terminal device 120, an application server 130 and a chatbot server 140.

The network 110 may be any type of networks capable of interconnecting network entities. The network 110 may be a single network or a combination of various networks. In terms of coverage range, the network 110 may be a Local Area Network (LAN), a Wide Area Network (WAN), etc. In terms of carrying medium, the network 110 may be a wireline network, a wireless network, etc. In terms of data switching techniques, the network 110 may be a circuit switching network, a packet switching network, etc.

The terminal device 120 may be any type of computing device capable of connecting to the network 110, assessing servers or websites over the network 110, processing data or signals, etc. For example, the terminal device 120 may be a desktop computer, a laptop, a tablet, a smart phone, etc. Although only one terminal device 120 is shown in FIG. 1, it should be appreciated that a different number of terminal devices may connect to the network 110.

The terminal device 120 may include a chatbot client 122 which may provide a chat service for a user. In some implementations, the chatbot client 122 at the terminal device 120 may be an independent client application corresponding to the chatbot service provided by the chatbot server 140. In some other implementations, the chatbot client 122 at the terminal device 120 may be implemented in a third party application such as a third party instant messaging (IM) application. Examples of the third party IM message comprise MSN™, ICQ™, SKYPE™, QQ™, WeChat™ and so on.

The chatbot client 122 communicates with the chatbot server 140. For example, the chatbot client 122 may transmit messages inputted by a user to the chatbot server 140, and receive responses associated with the messages from the chatbot server 140. The chatbot client 122 and the chatbot server 140 may be collectively referred to as a chatbot. As the conversation between the user and the chatbot is performed typically in a query-response manner, the messages inputted by the user are commonly referred to as queries, and the answers outputted by the chatbot are commonly referred to as responses. The query-response pairs may be recorded as user long data. It should be appreciated that, in some implementations, instead of interacting with the chatbot server 140, the chatbot client 122 may also locally generate responses to queries inputted by the player.

An application 124 may be activated during a conversation between the chatbot and a user. For example, the application 124 may be associated with a trigger word. The user may input the trigger word when the user wants to start the application 124 during the conversation. After receiving the trigger word, the chatbot may activate the application during the conversation.

In some implementations, the application 124 may be implemented at an application server 130, which may be a third part application server. For example, while the application 124 is active during the conversation, a query from a user is sent to the application server 130 via the chatbot, and a response from the application server 130 is sent to the user via the chatbot. In some other implementations, the application 124 may be implemented at the Chabot server 140, and in this case an application module 142 may be implemented at the chatbot server 140. Applications provided by the chatbot service provider and/or applications provided by third party application providers may be implemented at the application module 142. The chatbot may call an application at the application module 142 in order to activate the application during the conversation.

It should be appreciated that the application 124 associated with the chatbot service may also be referred to as a feature, a function, an applet, or the like, which is used to satisfy a relatively independent requirement of a user during a machine conversation with the user.

It should be appreciated that all the network entities shown in FIG. 1 are exemplary, and depending on specific application requirements, any other network entities may be involved in the environment 100.

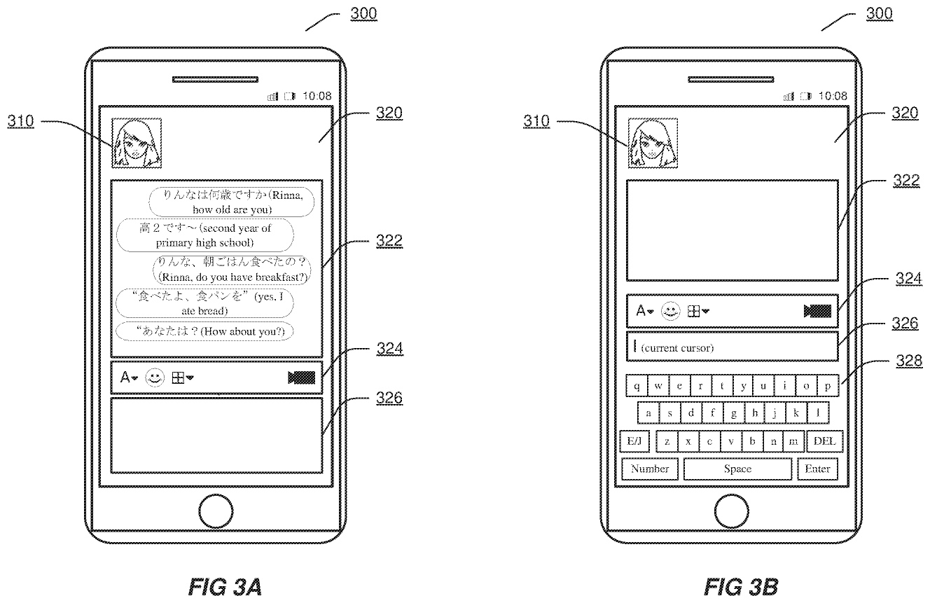

FIG. 2 illustrates an exemplary chatbot system 200 according to an embodiment.

The system 200 may comprise a user interface (UI) 210. The UI 210 may be implemented at the chatbot client 122, and provide a chat window for interacting between a user and the chatbot.

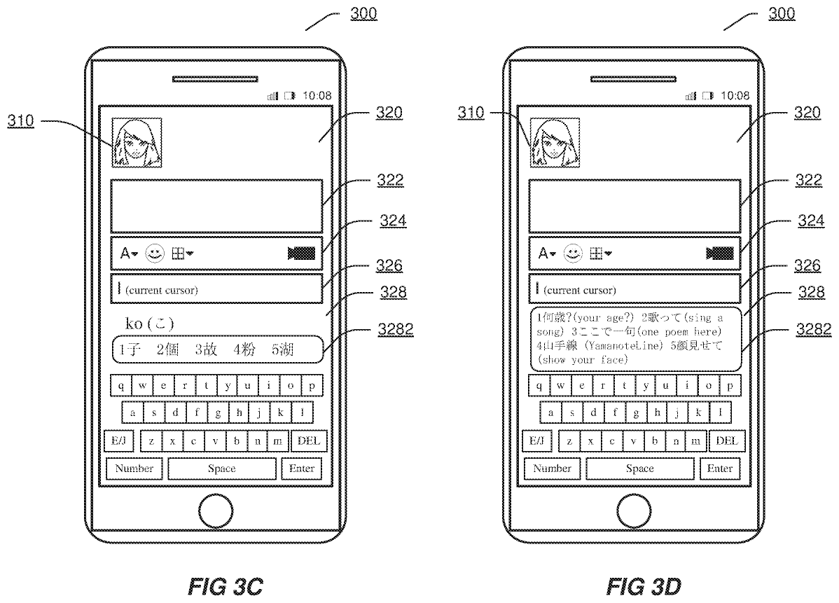

FIG. 3A illustrates an example of the UI 210. A chat window 320 is displayed on a computing device 300. The chat window 320 comprises a message flow area 322, a control area 324 and an input area 326. The message flow area 322 presents queries and responses in a conversation between a user and a chatbot, which is represented by the icon 310. The control area 324 includes a plurality of virtual buttons for the user to perform message input settings. For example, the user may make a voice input, attach image file, select emoji symbols, and make a short-cut of current screen, and so on through the control area 324. The input area 326 is used for the user to input messages. For example, the user may type text through the input area 326 by means of IME. The text input through the IME may include words, phrases, sentences, or even emoji symbols if supported by the IME. The control area 324 and the input area 326 may be collectively referred to as input unit. The user may also make a voice call or video conversation with the AI chatbot though the input unit.

The IME may enable the user to input message in a certain language. Taking Japanese language as an example, in the UI as shown in FIG. 3, the user inputs a message “ [symbol] [symbol] (Rinna, how old are you)” as a query by using an IME, and a message “ [symbol] 2 [symbol] (second year of primary high school)” may be output by the chatbot as a response. Similarly, the user inputs a message “ [symbol] [symbol] [symbol] ? (Rinna, do you have breakfast?)” as a query by using the IME, and two messages “ [symbol] [symbol] ” (yes, I ate bread)” and “ [symbol] [symbol] ? (How about you?)” may be outputted by the chatbot as a response. It should be appreciated that the two messages may be taken as a single response and may be output in one message by the chatbot. Here, Rinna is the name of the AI chatbot, which may also be referred to as AI chat system. It should be appreciated that the English texts in the parentheses following the Japanese texts in the description and the Figures are translations of the Japanese texts for sake of understanding, and are not actually presented in the message flow of the conversation.

The queries from the user are transferred to the query queue 232, which temporarily stores users' queries. The users' queries may be in various forms including text, sound, image, video, and so on.

The core processing module 220 may take the messages or queries in the query queue 232 as its input. In some implements, queries in the queue 232 may be served or responded in first-in-first-out manner.

The core processing module 220 may invoke processing units in an application program interface (API) module 250 for processing various forms of messages. The API module 250 may comprise a text processing unit 252, a speech processing unit 254, an image processing unit 256, etc.

For a text message, the text processing unit 252 may perform text understanding on the text message, and the core processing module 220 may further determine a text response.

For a speech message, the speech processing unit 254 may perform a speech-to-text conversion on the speech message to obtain text, the text processing unit 252 may perform text understanding on the obtained text, and the core processing module 220 may further determine a text response. If it is determined to provide a response in speech, the speech processing unit 254 may perform a text-to-speech conversion on the text response to generate a corresponding speech response.

For an image message, the image processing unit 256 may perform image recognition on the image message to generate corresponding text, and the core processing module 220 may further determine a text response. For example, when receiving a dog image from the user, the AI chat system may determine the type and color of the dog and further gives a number of comments, such as “So cute German shepherd! You must love it very much”. In some cases, the image processing unit 256 may also be used for obtaining an image response based on the text response.

Moreover, although not shown in FIG. 2, the API module 250 may comprise any other processing units. For example, the API module 250 may comprise a video processing unit for cooperating with the core processing module 220 to process a video message and determine a response. For another example, the. API module 250 may comprise a location-based processing unit for supporting location-based services.

After receiving a query from a user, the core processing module 220 may determine a response through an index database 260. The index database 260 may comprise a plurality of index items that can be retrieved by the core processing module 220 as responses. The index database 260 may include a question-answer pair index set 262 and a pure chat index set 264. In addition, the index database 260 may include an IME index set 266. Index items in the question-answer pair index set 262 are in a form of question-answer pairs, and the question-answer pair index set 262 may comprise question-answer pairs associated with an application such as the application 124 implemented through the chatbot system. Index items in the pure chat index set 264 are prepared for free chatting between the user and the chatbot, and may or may not be in a form of question-answer pairs. Index items in the IME index set 266 are prepared for an IME to find candidate messages for the user. It should be appreciated that the term question-answer pair may also be referred to as query-response pair or any other suitable terms.

The responses determined by the core processing module 220 may be provided to a response queue or response cache 234. The responses in the response queue or response cache 234 may be further transferred to the user interface 210 such that the responses can be presented to the user in an proper order.

A user database 270 in the system 200 is used to record user data occurred in conversations between users and the chatbot. The user database 270 may comprise a user log database 272 and a user-application usage database 274.

The user log database 272 may be used to record messages occurred in conversations between users and the chatbot. For example, the user log database 272 may be used to record user log data of pure chat. For another example, the user log database 272 may be used to record not only the user log data of pure chat but also user log data occurred while an application is active. The user log data may be in a query-response pair form, or may be in any other suitable form. The user-application usage database 274 may be used to store every user's usage information of applications associated with the chatbot or the AI chat service.

FIG. 3B illustrates an exemplary interface of an IME during a conversation session between a user and a chatbot according to an embodiment. It should be appreciated the “during a conversation session” refers to at any time of a conversation session, such as at the beginning, in the middle or at the end of the conversation session.

In some implementations, when a user taps the input area 326 shown in FIG. 3A, an IME may be activated and an interface 328 of the IME may be presented as shown in FIG. 3B. The activation of the input area 326 used for the conversation session indicates a user's intention of inputting, then the IME may be activated and the IME interface 328 may be presented in response to the intention of inputting. In some implementations, the IME may be called when the input area 326 is activated, and the intention of inputting may be identified by the calling of the IME.

In the illustrated example, the IME may be a Japanese IME used for inputting Japanese text such as words, phrases, sentences, or even emoji symbols, or the like. Currently the IME interface 328 includes a virtual keyboard. The keyboard includes virtual keys representing English characters or letters A to Z, as well as virtual keys representing certain functions such as delete, number, enter, space, E/J (English/Japanese) shift. It should be appreciated that the keyboard may include more or less keys representing more or less functions or symbols.

When the “E/J” key is tapped, the English keyboard may be shifted to a Japanese keyboard, which is not shown in the Figures for sake of simplicity. The Japanese keyboard provides Japanese characters typically referred to as kana. The English keyboard and the Japanese keyboard have the equivalent effects for users to input Japanese text. That is, English characters and Japanese kana may be equivalently used in the IME to input Japanese text, for example, English character “a” represents kana “ [symbol] ”, “ka” represents “ [symbol] ”, and so on.

The symbol “ [symbol] ” in the input area 326 shows the position of the cursor. In some implementations, the symbol “ [symbol] ” is flickering in the input area 326, indicating that the input area is active.

FIG. 3C illustrates an exemplary interface of an IME during a. conversation session between a user and a chatbot according to an embodiment.

When a user types or inputs English character “ko”, which represents kana “ [symbol] ”, in the IME interface 328 shown in FIG. 3B, kanji candidates corresponding to the kana “ [symbol] ” are provided in the IME interface 328, specifically in a candidate presenting area 3282. If the user selects the third candidate in the area 3282, this kanji may be presented in the input area 326 as the output of the IME. In this way, Japanese text may be typed into the input area 326 used for the conversation by using the IME.

At this time, the IME interface 328 includes the area presenting the typed character such as “ko” and the candidate presenting area 3282 in addition to the keyboard area. It should be appreciated that the disclosure is not limited to any specific form of the IME interface. For example, the typed character such as “ko” may be presented in the inputting area 326, and may be changed to desired kanji such as “ [symbol] ” as the output of the IME when the third candidate is selected.

FIG. 3D illustrates an exemplary interface of an IME during a conversation session between a user and a chatbot according to an embodiment.

The IME interface 328 may be presented at the beginning of the conversation session. One or more candidate messages are provided in the IME interface 382, specifically in the candidate presenting area 3282 of the IME interface 328, before any character or letter is input into the IME interface through the keyboard. Examples of the character may be English letter, Japanese kana, Korean vowel and consonant, and so on.

The candidate messages provided in the IME interface 382 before a character is input into the IME interface 382 may be referred to as “next queries”, which are complete queries that may be output by the user in the conversation session with the chatbot.

The next queries are automatically generated by the IME without needing receipt of any character from the user. In some implementations, the generation of the next queries are be implemented at the chatbot system. The next queries may include the most frequently asked questions or requests from multiple users such as a large amount of users to the chatbot, which reflect the statistical interest of the multiple users, may include most frequently asked questions or requests from the current user, which reflect the statistical interest of the current user, may include trigger words of a recommended application such as a new application, which reflect the application recommendation information, or may include small talk content such as greetings, cute emoji symbols or the like. Examples of the next queries include “1 [symbol] (your age, or how old are you)”, “2 [symbol] (sing a song)”, “3 [symbol] (one poem here)” “4 [symbol] (Yamanote Line)”, “5 [symbol] (show your face), as illustrated in the FIG. 3D.

When a user selects one of the next queries, the selected next query such as the fourth one “ [symbol] (Yamanote Line)” may be provided in the input area 326 as the output of the IME, and may then be output in the conversation session in the area 322 by the user. In this example, the exemplary query “ [symbol] (Yamanote Line)” is a keyword of an application, and accordingly the chatbot may activate the application in response to the query output by the user.

In addition to the high frequency applications, the chatbot's new applications may be recommended to the user in a proactive way through the IME to enrich users' using habit of chatbots. This would reduce the use threshold of the chatbot.

In case the user's first usage of the chatbot or the user is not familiar with the chatbot, the automatic suggestion of next queries through the IME is helpful for the user to reduce the usage obstacle of communicating with the chatbot. Furthermore, since the next queries come from high frequency questions asked by the current user or multiple users or high frequency applications used by the current user or multiple users, the beforehand suggestion in the IME can grasp user's attention in a good way and then easy to increase the engagement rate of the user to the chatbot.

FIG. 3E illustrates an exemplary interface of an IME during a conversation session between a user and a chatbot according to an embodiment.

The IME interface 328 may be presented in the middle of the conversation session. Similar to the interface of FIG. 3D, candidate messages are provided in the IME interface 382, specifically in the candidate presenting area 3282 of the IME interface 328, before a character is input into the IME interface through the keyboard.

As illustrated in FIG. 3E, two messages are shown in the current conversation session in area 322. There may be more messages in the current session, which are out of the screen. A session may be defined by a flow of messages communicated in the conversation, where any two consecutive messages in a session should be output within a predefined time distance such as 30 minutes. That is, if the user does not send anything in the exemplary 30 minutes from the chatbot's last response, then current session ends. And when the user begins to send a message to the chatbot, a new session starts.

The IME may automatically predict the next queries based on the chatbot's last response, e.g., “ [symbol] [symbol] [symbol] ? (Good morning. Did you eat breakfast?), and/or the current session, i.e., the list of messages existed in the current session. In the illustrated example, subsequent to the chatbot's last response, the candidate next queries such as “1 [symbol] ate)”, “2 [symbol] (not yet)”, “3 [symbol] (will eat from now on or soon later)” are automatically generated and provided in the IME interface 328 before a character is typed into the IME interface 328. The candidate next queries are related to the chatbot's last response and may be selected by the user to output as next query in the conversation session.

In some implementations, the type of the next query may be firstly predicted based on the chatbot's last response and the current session, and the candidate next queries may be predicted based at least in part on the predicted type. A list of next query types may be defined, example of the next query types includes “emotional feedback”, “go deeper to current topic”, “go wilder by jumping from current topic to a new topic”, and “specific requirement related to current session”, which may be referred to as type A, B, C and D.

In some implementations, a classifier may be trained to predict the probabilities of the types of the next query based on the chatbot's last response and the current session, and a learn to rank (LTR) model may be trained to predict the probabilities of the candidate next queries based on the next query type, the chatbot's last response and the current session.

A scenario for “emotional feedback” is illustrated in FIG. 3E, all the candidate next queries provided in the IME interface 328 are emotional feedbacks to the chatbot's last response which is a question.

FIG. 3F illustrates an exemplary interface of an IME during a conversation session between a user and a chatbot according to an embodiment.

The IME interface 328 may be presented in the middle of the conversation session. Similar to the IME interface of FIG. 3E, candidate messages are provided in the IME interface 382, specifically in the candidate presenting area 3282 of the IME interface 328, before any character is input into the IME interface through the keyboard.

A scenario for “go deeper to current topic” is illustrated in FIG. 3F. The next query type is firstly predicted based on the chatbot's last response “ [symbol] [symbol] [symbol] (of course, I was fully touched.)” and the current session, then the predicted candidate next queries are provided in the IME interface, such as “1 [symbol] [symbol] [symbol] [symbol] (Certainly, I still remember the sentences that the grandma talked at the end of the movie.)”, “2 [symbol] [symbol] [symbol] (Yes, and the scenes of the fireworks were interesting.)”, “3 [symbol] [symbol] (After watching the movie, I feel that I should concentrate on my work/job,)”, which are messages that go deeper to current movie topic and supply more details.

FIG. 3G illustrates an exemplary interface of an IME during a conversation session between a user and a chatbot according to an embodiment.

Similar to the IME interface of FIG. 3F, candidate messages are provided in the IME interface 382, specifically in the candidate presenting area 3282 of the IME interface 328, before a character is input into the IME interface through the keyboard.

The next query type is firstly predicted based on the chatbot's last response “ [symbol] [symbol] (By the way, do you watch movies currently?)” and the current session as shown in area 322 of FIG. 3G, then the predicted candidate next queries are provided in the IME interface 328, such as “1 [symbol] [symbol] ┌ [symbol] ┘ [symbol] [symbol] (Yes, I am watching. For example, another movie called “Departures”, I was far more touched and streamed down with more tears)”, which is a message that go wider to a new topic such as a new movie, “2 [symbol] ? (Do you have any recommendations?)”, which is a message that shows a specific requirement to the chatbot.

FIG. 3H illustrates an exemplary interface of an IME during a conversation session between a user and a chatbot according to an embodiment.

In this embodiment, rather than selecting one of the candidate next queries provided in the IME interface as shown in FIGS. 3D to 3G, the user types Japanese text through the keyboard of the IME, similarly as illustrated in FIG. 3C. As illustrated in FIG. 3H, after a word such as “ [symbol] (belly, stomach)” is selected or typed by the user, candidate next words and/or phrases are automatically predicted and provided in the IME interface 328 before a character other than those corresponding to the existing word. “ [symbol] (belly, stomach)” is additionally typed into the IME interface. The candidate next words and/or phrases are predicted based on the given words/phrases or partial sentence that user already typed. In the FIG. 3H, the example shows the possible “next words” of “1 [symbol] (hungry)”, “2 [symbol] (hungry)”, “3 [symbol] (pain)”, “4 [symbol] (full of food)” following the pre-typed word “ [symbol] (belly, stomach)”.

In an example of candidate next phrase in chunk level, given “ [symbol] (movie)” that the user already typed, the candidate next phrases may include “ [symbol] [symbol] ” (want to see a movie)”, “ [symbol] (‘s recommendation)”, “ [symbol] (‘s latest information,)” and so on.

By providing the candidate next queries and candidate next words and/or phrases, the IME system according to various embodiments may bring many advantages, especially in the scenario of conversation with chatbots. For example, the typing speed may be accelerated as the user is allowed to select suggested next queries or next words and/or phrases. The usage obstacle of chatbots may be reduced by means of the IME system as the IME provides an entrance for provide recommendations.

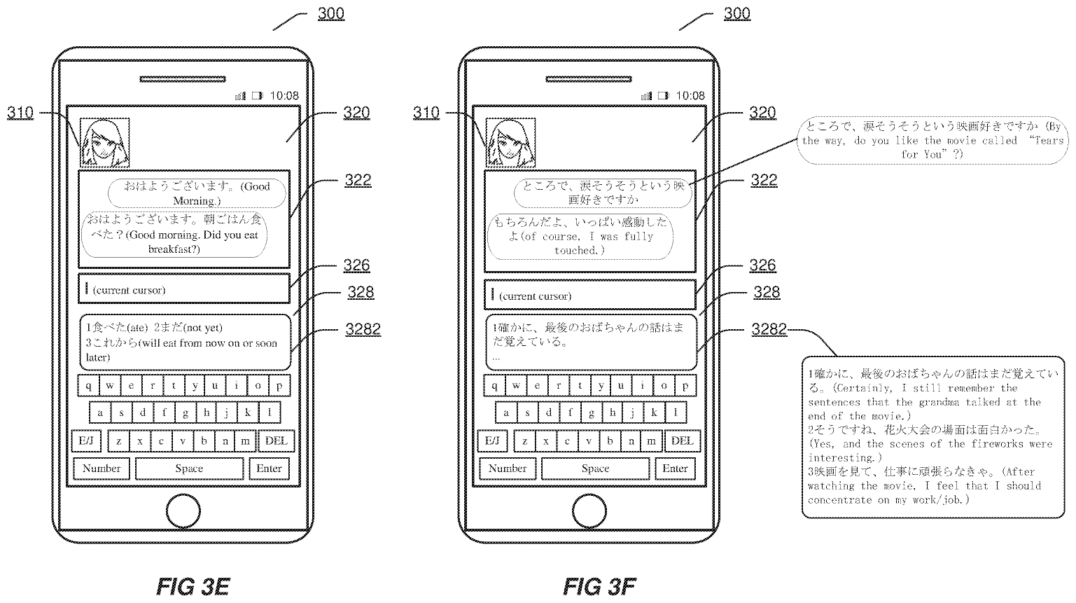

FIG. 4 illustrates an exemplary process 400 for collecting training data according to an embodiment.

Two data sources, user log data 402 and web data 416, are used to collect the training data.

The user log data 402 is a collection of user-chatbot communication records in the form of <query, response> pairs, where the query comes from the user side and the response comes from the chatbot side. The user log data may be obtained from the user log database 272 shown in FIG. 2.

The web data 416 are obtained from website and are classified by domains. An example of the web data may a movie “ [symbol] (Tears for you)” related html data, which is obtained from a movie-related website and which contains the story introduction of the movie, the roles in the movie, the comments from watchers where positive/negative/impressive details are mentioned.

There are two streams from the data sources where the first stream yields the training data for next query type A and D and the second stream yields the training data for next query type B and C.

For the first stream, the user log data are organized by users and by sessions. In some implementations, the log data for each user are firstly collected, and then, making use of timestamp information of the log data, the list of logs for one user are grouped into a group of sessions. As discussed above, a session may be defined by a flow of messages communicated in the conversation, where any two consecutive messages in a session should be output within a predefined time distance such as 30 minutes. That is, if the user does not send anything in the exemplary 30 minutes from the chatbot's last response, then current session ends. And when the user begins to send a message to the chatbot, a new session starts. The logs of the user may be separated wherever there is an interval of 30 minutes, and thus are grouped by sessions.

An example of log data in unit of sessions is illustrated in block 404 of FIG. 4. There are three sessions for one user, <q1, r1> to <q3, r3> for the first session, <q4, r4> to <q6, r6> for the second session, and <q7, r7> to <q9, r9> for the third session. Here, q is user's query and r is chatbot's response. It should be appreciated that, as the log data are grouped by users, the personalized data may help to capture the different personal tendencies during using the IME for chatting with the chatbot.

As illustrated in 406 and 408, two judgements are made to collect training data for next query type A, which is “emotional feedbacks”. The first judgement is “is rᵢ₋₁ a question?” at 406 and the second judgement is “is qᵢ an answer or with positive or negative emotions?” at 408. If the two judgements are positive, the current <rᵢ₋₁, qᵢ> is taken as a training pair for type A, as shown in 410.

For example, a training data for type A may b extracted from the user log data shown in FIG. 3E, where the training data pair includes the chatbot's former response which is a question “ [symbol] [symbol] [symbol] ? (Good morning. Did you eat breakfast?)” and the user selected query “ [symbol] (ate)” which is a positive emotional message. A sentiment analysis (SA) classifier may be to judge whether a given message or sentence is positive, negative, or neutral.

As illustrated in 412, one judgement “is qᵢ a question” is made to collect training data for next query type D, which is “specific requirements related to current session”. If the judgement is positive, the current <session, qᵢ> is taken as a training pair for type D, as shown in 414.

For example, if user selected “ [symbol] ? (Do you have any recommendations?)” in FIG. 3G, then the session of user log data shown in area 322 of FIG. 3G is taken as a training instance for type D.

For the second stream, a topic knowledge graph shown at 418 is built based on web data to organize the relationships between topics, example of the relationships may be “is-a”, “same level” or the like. For example, “Tears for you” and “Departures” are topics in the same level related to movie, and “scenes of firework” is included in “Tears for you”.

The next query type B and C are related to topic jump or not. A judgement “Do <qᵢ₋₁; rᵢ₋₁> and <qi, rᵢ> have same topic'’” is made at 420. If the judgement is positive, the current <session, qᵢ> is taken as a training pair for type B which is “go deeper to current topic” at 422, and if the judgement is negative, the current <session, qᵢ> is taken as a training pair for type C which is “go wilder by jumping from current topic to a new topic” at 424.

The training data collected at 410, 414, 422, 424 may be used to training the next query type classifier for predicting the types of the next queries.

After classifying the user log data into different types such as type A to D, an index set of <session, last response, next query type, next query> may be created at 426. The index set may be used to train a learning to rank model for finding candidate next queries.

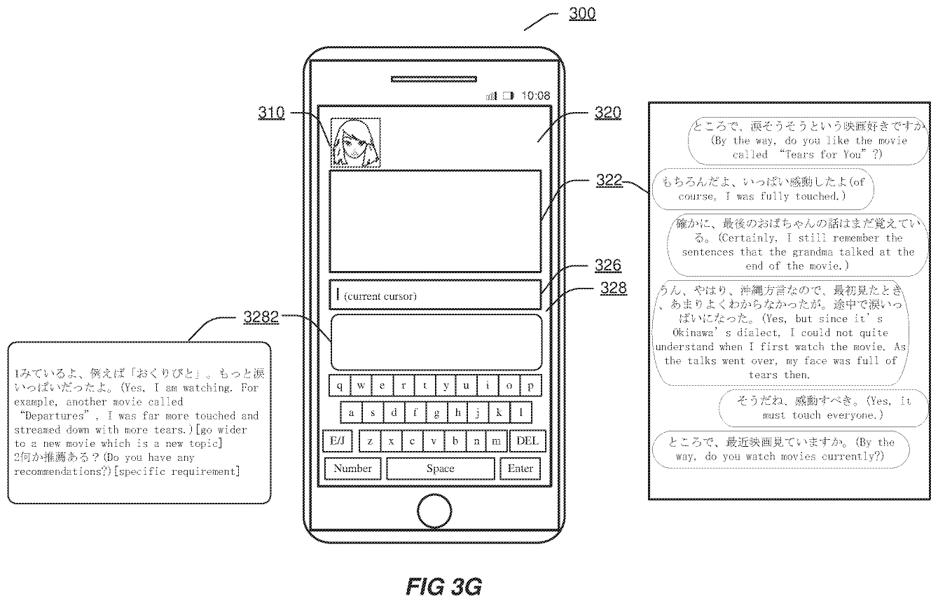

FIGS. 5A and 5C each illustrates an exemplary dependency tree for an example Japanese sentence, and FIG. 5B and 5D each illustrates an exemplary topic knowledge graph extracted from the dependency tree. The illustrated topic knowledge graphs are examples of the topic knowledge graphs at 418 that may be used to determine whether two <q, r> pairs are of the same topic or not.

Predicate-argument structures may be extracted from syntactic dependency trees of Japanese sentences and then topic knowledge graphs may be constructed.

Taking the Japanese sentence “ [symbol] [symbol] [symbol] [symbol] (Microsoft is a company that develops and sells software)” as an example, the part-of-speech (POS) of the words in the sentence as well as the dependency among the words may be structured. The dependency structure of the sentence may be illustrated as the dependent tree of FIG. 5A, where following predicate-argument structures may be mined, and the dependency relations may be described in the topic knowledge graphs of FIG. 5B.

| argument 1 | argument 2 | predicate |
|---|---|---|
| [symbol] (Microsoft) | [symbol] (company) | [symbol] (is) |
| [symbol] (Microsoft) | [symbol] (software) | [symbol] (develop) |
| [symbol] (Microsoft) | [symbol] (software) | [symbol] (sell) |

For another example Japanese sentence “┌ [symbol] ┘ [symbol] ┌ [symbol] [symbol] ┘ [symbol] (“Tears for you” and “Departures” are famous movies)”, the dependency tree and the related topic knowledge graph may be obtained as illustrated in FIG. 5D. Both the “is-a” relation shown in 5B and the “same level” relation shown in 5D may be used to indicate the same topic. And the determination of whether two <q, r> pairs are of the same topic or not may be made based on the topic knowledge graphs.

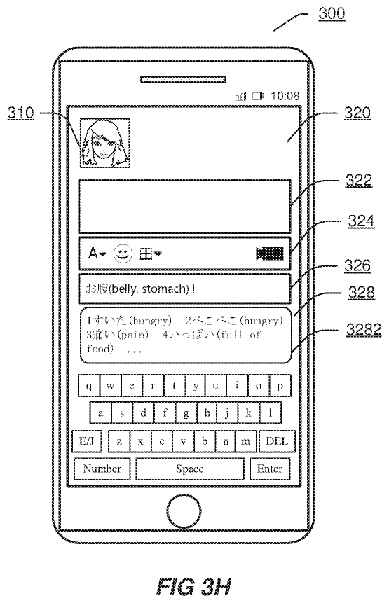

FIG. 6 illustrates an exemplary process 600 for training a classifier for predicting next query type according to an embodiment.

User log data 602 is same as user log data 402. At 604, the training data for each user are collected through the process from 402 to 424 shown in FIG. 4.

All the training data collected for each user may be combined at 606. And the combined training data may be used to train a universal classifier for all users at 608. The universal classifier is a user-independent classifier, which may be denoted as Pₐₗₗ. The universal classifier may be used to cover the long-tail users, that is, users who do not have large-scale log data.

In some implementations, a logistic regression algorithm may be used for training the classifier based on the training data. The exemplary features used in the logistic regression algorithm may include at least part of:
Is rᵢ₋₁ (i.e., chatbot's last response) a question?
Is qᵢ (i.e., user query subsequent to rᵢ₋₁) an answer or with positive or negative emotions?
Is qᵢ a question?
Do <qᵢ₋₁, rᵢ₋₁> and <qᵢ, rᵢ> have same topic?
Word ngrams: unigrams and bigrams for words in current session and in the chatbot's last response.
Character ngrams: for each word in the current session and in the chatbot's last response, character ngrams such as 4-grams and 5-grams are extracted.
Word skip-grams: for all the trigrams and 4-grams in the current session and in the chatbot's last response, one of the words is replaced by * to indicate the presence of non-contiguous words.
Brown cluster n-grams: Brown clusters are used to represent words (in current session and in the chatbot's last response), and unigrams and bigrams are extracted as features.
POS tags: the presence or absence of POS tags in the current session and in the chatbot's last response are used as binary features.
Social network related words: number (in the current session and in the chatbot's last response) of hashtags, emoticons, elongated words, and punctuations are used as features.
Word2vec cluster ngrams: the word2vec tool is used to learn 100-dimensional word embedding from a social network dataset. Then, K-means algorithm and L2 distance of word vectors may be used to cluster the million-level vocabulary into 200 classes. The classes are used to represent generalized words in current session and in the chatbot's last response.

A judgement “amount of training data of a certain user>threshold” is made at 610, An example of the threshold may be 10000 <query, response> pairs. If the judgement is positive, that means the certain user have already communicated a lot of data with the chatbot, a specific classifier may be trained for the certain user based on the training data of the user. The specific classifier may be denoted as Pᵤₛₑᵣ.

The trained classifier Pₐₗₗ is used to estimate probabilities of next query types such as the types A to D independent of users, that is, Pₐₗₗ (next query type|current session, chatbot's last response) taking the current session and the chatbot's last response as input. The trained classifier Pᵤₛₑᵣ is used to estimate probabilities of next query types such as the types A to D for the current user, that is, Pᵤₛₑᵣ (next query type|current session, chatbot's last response, user) taking the current session and the chatbot's last response as input.

The two kinds of classifiers may be jointly used and the type of the next query may be predicted as follows:

P(next query type|current session, chatbot's last response, user)=λ*Pₐₗₗ(1−λ)*Pᵤₛₑᵣ (1)

Here λ is a pre-defined value, such as taking a value of 0.8.

For a user who does not have a user-specific classifier, the P(next query type|current session, chatbot's last response, user) for this user may be taken the value of Pₐₗₗ.

For a user who has a user-specific classifier, the P(next query type|current session, chatbot's last response, user) for this user may be taken the value of Pᵤₛₑᵣ instead of using equation (1).

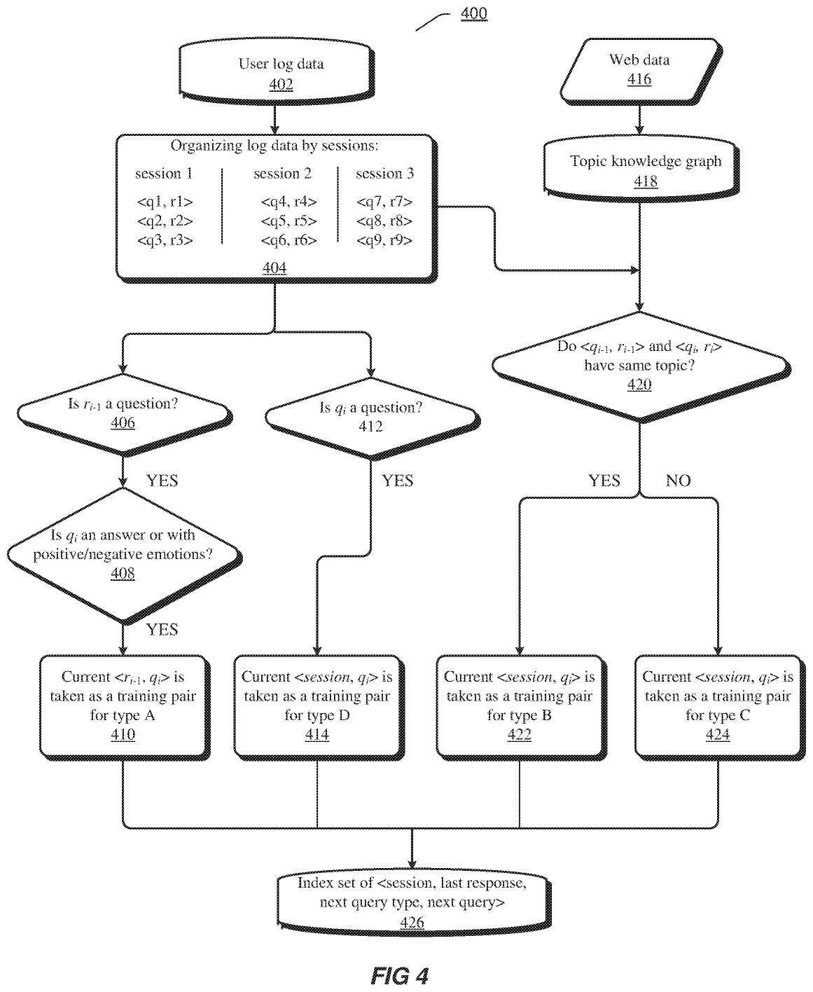

FIG. 7 illustrates an exemplary process 700 for predicting candidate next pieties according to an embodiment.

After estimating the probabilities of next query types based on the current session and the chatbot's last response by using the next query type classifier, learning-to-rank (LTR) information retrieval (IR) model 706 may be used to find next queries.

The Index set of <session, last response, next query type, next query> 702 is obtained at 426 of FIG. 4 through the training data collection process. The LTR IR model 706 takes the current session, chatbot's last response, next query type as input 704, and finds candidate next queries with high ranking scores 708 from the index set 702.

In some implementation, a gradient boosted decision trees (GBDT) ranker may be trained to implement the LTR IR model 706. The exemplary features that may be used in the GBDT ranker includes at least part of:
Edit distance of character/word level unigrams between the current session and a candidate next query;
Edit distance of character/word level unigrams between the chatbot's last response and a candidate next query;
Maximum subsequence ratio between the current session and a candidate next query;
Maximum subsequence ratio between the chatbot's last response and a candidate next query;
The type of a candidate next query;
BM25 (BM stands for Best Matching) scores given <current session, chatbot's last response> and a candidate next query.

Given a current session, a chatbot's last response, a next query type, a GBDT score may generated through the GBDT ranker, the GBDT score may be denoted as GBDT(next query|next query type, current session, chatbot's last response), which may be used as score of P(next query|next query type, current session, chatbot's last response, user), where P stands for probability.

In some implementations, as the GBDT scores are computed without considering the difference of different users, in to take individual differences into consideration, the score of P(next query|next query type, current session, chatbot's last response, user) may be computed using the following equation:

P(next query|next query type, current session, chatbot's last response, user)=λ*GBDT(next query|next query type, current session, chatbot's last response)+(1−λ)*punish_score(is candidate next query said by the user) (2)

Here, if the candidate next query is formerly output by the specific user, the punish score can be 0; otherwise, it is a minus value to discount the GBDT score. Through this way, the candidate next query that was previously used by current user may be given a relatively higher ranking score. The parameter λ here may be a predefined value.

Finally the final ranking score of a candidate next query given a current session, chatbot's last response and user may be obtained by the following equation:

P(next query|user)=Σ_{(next query type)}{P(next query type|current session, chatbot's last response, user)*P(next query|next query type, current session, chatbot's last response, user)} (3)

The candidate next queries with the highest ranking scores found from the index set 702 may be provided in the IME interface before any character is typed into the IME interface.

Although the GBDT score is used to compute the score of the next query in the LTR model, it's also possible that BM25 score is used to compute the score of the next query in place of the GBDT score in order for faster processing in a simplified implementation, where BM 25 provides a good performance for ranking matching documents according to their relevance to a given search query.

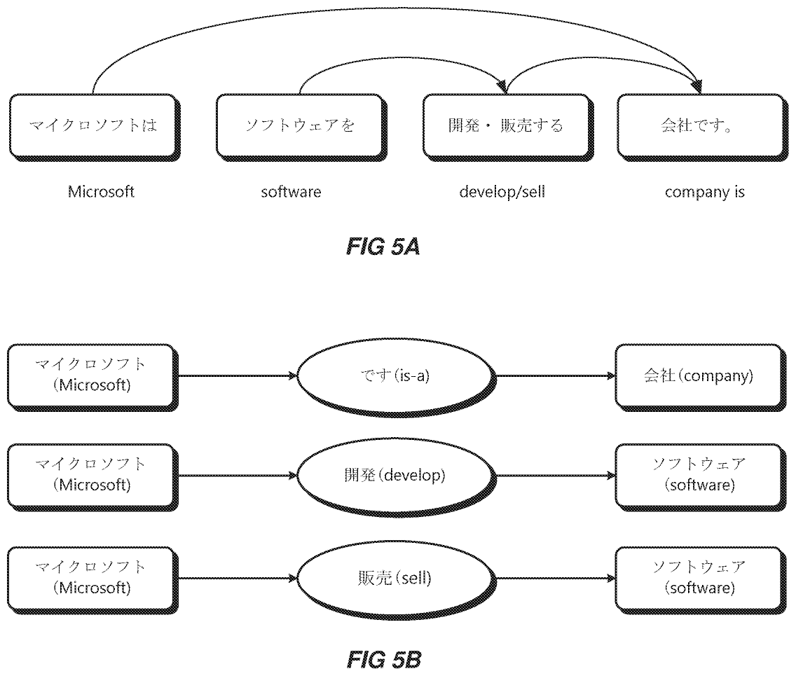

FIG. 8 illustrates an exemplary structure 800 of a part of an IME system according to an embodiment.

Taking Japanese IME as an example, the basic function is to provide the most reasonable Kanji sequence from a given Kana sequence. The IME system includes a basic lexicon 806, a compound lexicon 808, a n-POS model 810, and a n-gram language model 812.

In some implementations, the exemplary kana-kanji conversion part 800 of the IME system is constructed based on the n-POS model 810, where POS stands for Part-Of-Speech, such as noun, verb, adjective and so on for classifying words. For statistical Kana-Kanji conversion, the optimal mixed Kana-Kanji sequence ŷ (=w₁ . . . wₙ) may be predicated from the input kana sequence x through the following equations.

\hat{y}=argmax_{y}P(y)P(x|y) (4)

P(y)=Πᵢ₌₁ⁿP(wᵢ|cᵢ)P(cᵢ|c₋₁) (5)

P(x|y)=Πᵢ₌₁ⁿP(rᵢ|wᵢ) (6)

Here P(ci|ci−1) is the bi-gram POS tag model; P(wi|ci) POS-to-word model, from ci to a word wi; and P(ri|wi) the pronunciation model, from wi to its Kana pronunciation ri. For example, suppose x is “ [symbol] ” and y can take values of or “ [symbol] ” or “ [symbol] ”.
For y=“ [symbol] ”, P(x|y) takes the value of the production of P(ri|wi):

P(x|y)=P(“ [symbol] ” [symbol] “ [symbol] ”)=P( [symbol] )*P( [symbol] [symbol] )*P( [symbol] ).
For y=“ [symbol] ”, P(y) takes the value of the production of P(wi|ci) P(ci|ci−1):

P(y)=P(w₁= [symbol] |c₁=Noun)*P(c₁=Noun|c₀=″″)*P(w₂= [symbol] |c₂=Particle)* P(c₂=Particle|c₁=Noun)*P(w₃= [symbol] |c₃=Verb)*P(c₃=Verb|c₂=Particle).

In order for training the n-POS model, TB-level Japanese Web data 804 may be taken as the training data. Word segmenting, POS tagging, and Kana pronunciation annotating may be performed on the training data. Then, these probabilities listed in Equations (4) to (6) may be estimated based on maximum likelihood estimation.

The basic lexicon 806 contains Japanese words (such as particles, adjectives, adverbs, verbs, nouns, etc.) with the highest frequencies and the most frequently used idioms. An entry in the basic lexicon 806 has the form of <wᵢ^{i+m}, cᵢ^{i+m}, rᵢ^{i+m}>. Here, wᵢ^{i+m} stands for m+1 words (of wᵢ . . . wᵢ₊ₘ). One word wᵢ exactly corresponds to one POS tag cᵢ and one Kana sequence rᵢ as its pronunciation. One word sequence with multiple reasonable POS sequences and/or Kana pronunciations will be stored separately as different entries.

The compound lexicon 808 contains new words, collocations, and predicate-argument phrases. Dependency parsing may be performed before data mining. For example, web sentences may be parsed by a state-of-the-art chunk-based Japanese dependency parser. The compound lexicon 808 may provide the most important context information, such as the strong constraints among predicates and arguments.

The n-POS model 810 with three kinds of probabilities may be used to search one or more best y from a given input Kana sequence x based on the lexicons.

In addition to or instead of the n-POS model 810, a n-gram language model 812 on surface word level may be trained. In an implementation, the only difference of the model 812 from the n-POS model 810 is the factorization of P(y):

P(y)=Πᵢ₌₁ⁿP(wᵢ|wᵢ₋₁, wᵢ₋₂, wᵢ₋₃) (7)

In some implementations, a cloud Kana-Kanji conversion service may be constructed through wireless network communication between a mobile device and the cloud. The basic lexicon 806, compound lexicon 808 and n-POS model 810 may be installed in the client device to be accessed during Kana-Kanji decoding using Equation (4). The n-gram language model 812, which works in a different way from the n-POS model 810, may be implemented at the cloud. Then the cloud generated m-best Kanji candidates may be merged into local client device generated n-best Kanji candidates. Duplicated Kanji candidates removing may be performed before the merging.

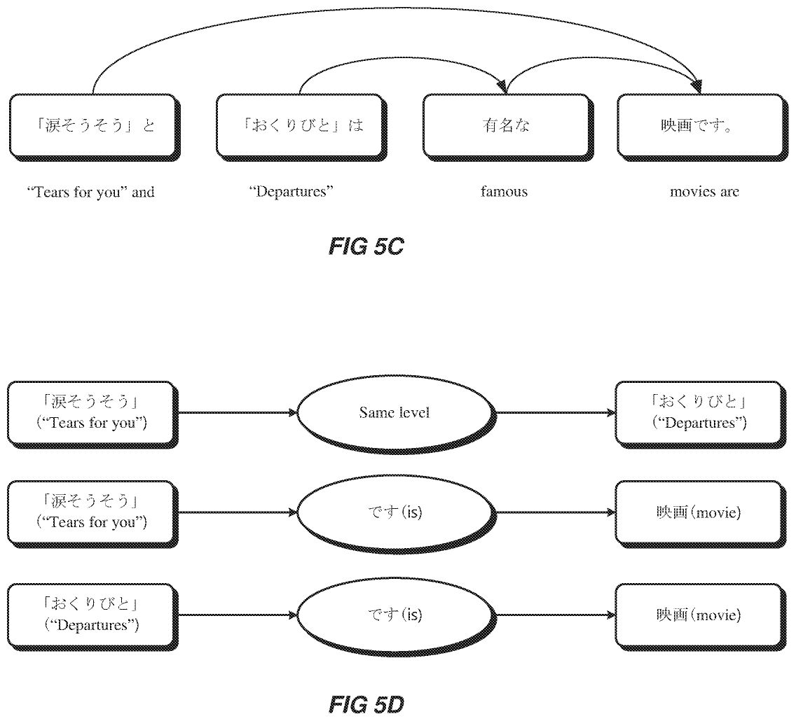

FIG. 9 illustrates an exemplary process 900 for training user sensitive word/phrase language models according to an embodiment.

User log data 902 is same as user log data 402. At 904, word segmentation and phrase segmentation processing is performed to the queries and responses of the user log data which are in the form of <query, response> pairs. At 906, the training data are collected for each user. For example, during the training data collection process 400, the training data at 906 may be collected for each user.

All the training data collected for each user may be combined at 908. And the combined training data may be used to train a universal user-sensitive n-gram word/chunk level language models at 910, which is used to predict next words and/or phrases based on already typed partial sentence, as shown in the IME interface of FIG. 3H. The universal language models may be used to cover the long-tail users, that is, users who do not have large-scale log data.

In some implementations, 4-gram word/chunk level language models may be trained by using the equation (7). The probability listed in Equations (7) may be estimated based on maximum likelihood estimation.

A judgement “amount of training data of a certain user >threshold” is made at 912. An example of the threshold may be 10000 <query, response> pairs. If the judgement is positive, that means the certain user has already communicated a lot of data with the chatbot, specific n-gram word/chunk level language models may be trained for the certain user based on the training data of the user. The universal models may be denoted as Pₐₗₗ. The specific models may be denoted as Pᵤₛₑᵣ.

The two kinds of n-gram word/chunk level language models may be jointly used to determine the score of the next word (wᵢ)/phrase (pᵢ) based on the typed words/phrases or partial sentence, which is referred to as “history” in the following equations:

P(wᵢ|History)=λ*Pₐₗₗ(wᵢ|History)+(1−λ)*Pᵤₛₑᵣ(wᵢ|History) (8)

P(pᵢ|History)=λ*Pₐₗₗ(pᵢ|History)+(1−λ)*Pᵤₛₑᵣ(pᵢ|History) (9)

Here λ is a pre-defined value, such as taking a value of 0.8.

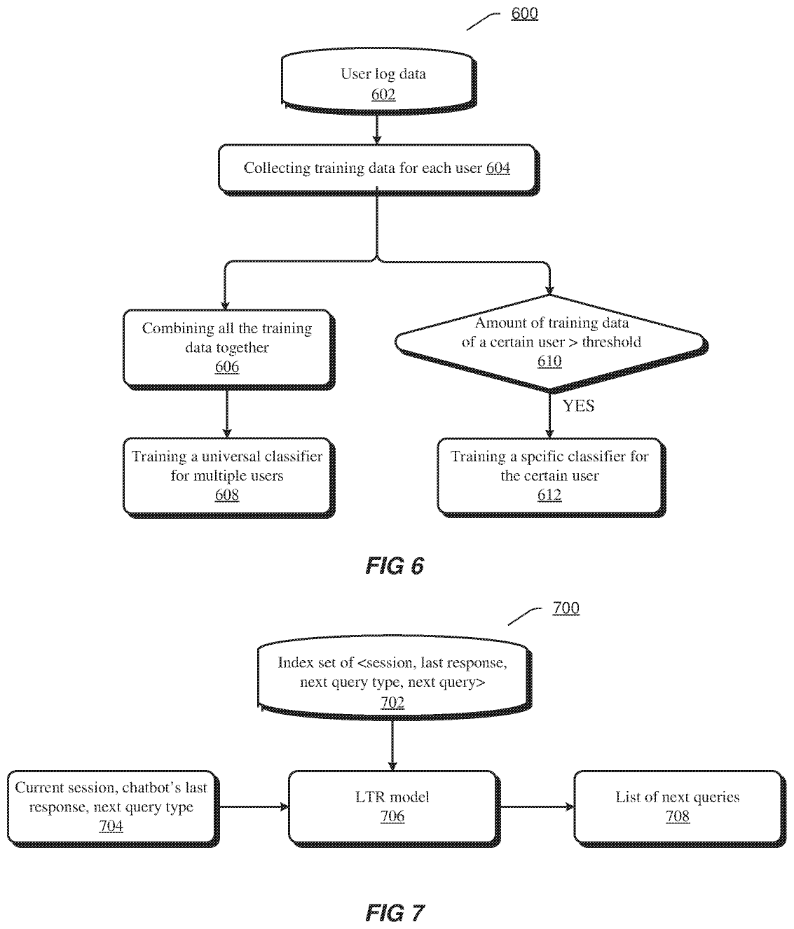

FIG. 10 illustrates an exemplary IME system 1000 according to an embodiment. The IME system 100 includes a next query prediction module 1010, a next word/phrase prediction module 1020 and a kana-kanji conversion module 1030. The next query prediction module 1010 may be implemented by the LTR model 706 shown in FIG. 7. The next word/phrase prediction module 1020 may be implemented by the n-gram word/chunk level language models trained at 910 and 914 of FIG. 9. The kana-kanji conversion module 1030 may be implemented by the n-POS model 810 and/or n-gram language model 812 shown in FIG. 8. It should be appreciated that more or less modules may be included in the IME system 10, and some parts of the modules may be implemented at client computing device such as terminal device 120, or at server computing device such as chatbot server 130 or a different server.

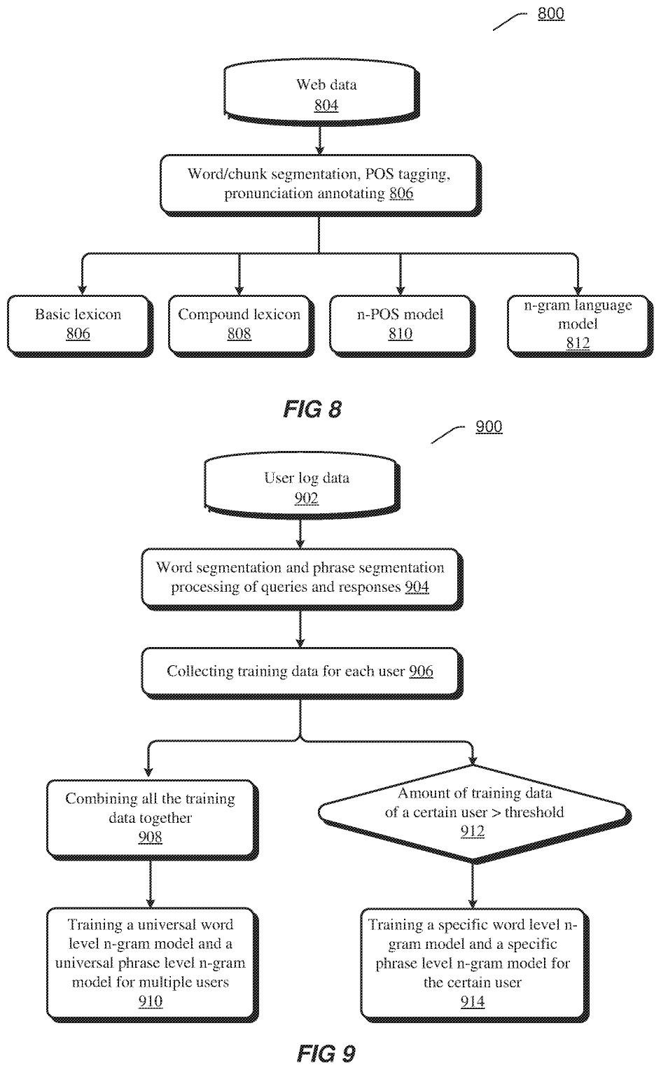

FIG. 11 illustrates an exemplary process 1100 for facilitating information input during a conversation session between a user a chatbot according to an embodiment.

At 1110, a call instruction of an IME is received. For example, when the input area 326 in the conversation interface is tapped by the user, the input area 326 may be activated and the IME may be called.

At 1112, it is determined whether there is a chatbot's last response from the current conversation session. For example, if it is at the beginning of the current session, the chatbot's last response may not be available.

At 1114, if the judgement at 1112 is negative, candidate next queries may be predicted for the user based on at least one of the current user's profile, multiple users' profiles, application recommendation information, small talk strategy and so on. The current user's profile may include information indicating statistical interest of a current user, for example, the current user's profile may include high frequently used queries or application of the user. The multiple users' profiles may include information indicating a statistical interest of multiple users, for example, high frequently used queries or applications of all or a large amount of the users may be determined based on the multiple users' profiles. The application recommendation information may be the trigger words of recommended applications. In this way, the IME may become an entrance for recommending applications or functions to users. The small talk may be some greetings such as how are you, what are you doing, good weather and so on.

At 1116, if the judgement at 1112 is positive, candidate next queries may be predicted for the user based on the chatbot's last response and/or the current conversation session. It should be appreciated that although it is specifically described that the candidate next queries are predicted based on the chatbot's last response and the current conversation session, the disclosure is not limited thereto and reasonable variation is applicable, for example, the candidate next queries may also be predicted based on the chatbot's last response without considering the current session.

At 1118, the candidate queries are presented in the IME interface in the case of no character such as a kana or an English character is typed into the IME interface.

At 1120, it is determined whether a user input is a selection of one of the candidate queries provided in the IME interface or a character string.

At 1122, if it is determined that the user input is a selection of one candidate query, the selected candidate query is provided as the output of the IME, for example, the selected candidate is provided in the input area 326 of the conversation interface,

At 1124, if it is determined that the user input is a character string such as kana string or English character string, candidate words and/or phrases corresponding to the character string are provided in the IME interface.

After the user makes selection from the candidate words and/or phrases, the selected words and/or phrases are identified by the IME at 1126. For example, the identified words and/or phrases may be provided in the input area 326 of the conversation interface, or may be still presented in the IME interface.

At 1128, candidate next words and/or phrases may be predicted based on the identified existing words and/or phrases, which may also be referred to as typed partial sentence. The prediction of the candidate next words and/or phrases may be performed by the next word/phase prediction module 1020. Then the candidate next words and/or phrases are provided in the IME interface at 1130.

At 1132, it is determined whether a user input is a selection of one of the candidate next words and/or phrases provided in the IME interface or a character string typed in the IME interface. If it is determined that the user input is a selection of one candidate word or phrase, the process goes to 1126. If it is determined that the user input is a character string such as kana string or English character string, the process goes to 1124.

It should be appreciated that the process 1100 is just illustrative rather than limit the scope of the disclosure. The operations are not necessarily performed in the illustrated specific order, and there may be more or less operations in the process.

Although the IME system is described in the above embodiments in connection with the FIGS. 1 to 11 by taking Japanese IME as an example, it should be appreciated that the techniques proposed in the disclosure are not limited to any specific language. The techniques proposed in the disclosure are also applicable to not only LME for non-English language such as Japanese, Chinese and Korean, but also IME for English language or the like. For example, the candidate next query prediction and the candidate next word and/or phrase prediction are applicable to English IME.

Although the IME system is described in the circumstance of conversation between users and chatbots, it should be appreciated that the IME may also be applicable to other conversation circumstances. For example, the IME is also applicable to a circumstance of conversation between users such as via an instant messaging (IM) tool. In this example, the chatbot is replaced with the other user of the conversation in the various embodiments of the disclosure. Since the AI chatting of chatbots intends to imitate real people and actually the chatbot is usually trained with real people's conversation data, the IME trained with user log data in a chatbot system is also applicable to conversation between users. For example, the universal models used for long tail users may be equivalently used for real people chatting circumstance. On the other hand, log data from real people conversation circumstance may also be used to train the IME instead of or in addition to the user log data of AI chatting.

It should be appreciated that the IME may be implemented in various ways. In some implementations, the IME system may be implemented as a lightweight AI system which may carry on the functions of the IME described herein. In some other implementation, the IME system may be implemented by utilizing some functions of the chatbot server. For example, the IME system may call the chatbot by taking the chatbot's last response as the query to allow the chatbot to find the response candidates as the candidate queries to be provided to the user by the IME. It should be appreciated reasonable variations may be made to the disclosure and would be in the scope of the disclosure.

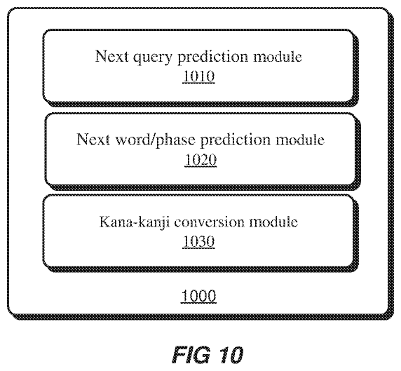

FIG. 12 illustrates an exemplary process 1200 for facilitating information input in a conversation session.

At 1210, an IME interface is presented during the conversation session. At 1220, one or more candidate messages are provided in the IME interface before a character is input into the IME interface.

It should be appreciated that the operations 1210 and 1220 are not limited to a specific order such as the operation 1210 is performed firstly and the operation is performed secondly. For example, in some implementations, at the very beginning of the IME is activated, the IME interface may be presented with the candidate messages having been provided in the IME interface. Then, during the process of one message is input by a user through the IME and sent in the conversation session, and another message is sent in the conversation session from another party, the IME may keep in active state and its interface is being presented during the conversation session. Then, when the response from the another part is received in the conversation session, the IME may automatically provide one or more candidate messages in the IME interface before a character is input into the IME interface. It should be appreciated that the character here refer to a language related character, such as English letter, Japanese kana, that is used to be converted to a corresponding text to be input by the user.

In some implementations, the IME interface is presented in response to an intention of inputting in the conversation session. For example, the intention of inputting may be identified or indicated by an activation of an input area used for the conversation session. The intention of inputting may be identified by a calling of the IME.

In some implementations, a selection of one of the one or more candidate messages may be received by the IME. The selected candidate message may be provided in the input area used for the conversation session.

In some implementations, first words and/or phrases which may also be referred to as partial sentence may be provided based on user inputs. One or more candidate second words and/or phrases may be provided in the IME interface based on the first words and/or phrases or historical partial sentence.

In some implementations, the one or more candidate messages may be predicted based on at least one of a statistical interest of a current user of the IME, a statistical interest of multiple users, an application recommendation information, a small talk strategy such as how are you, good weather and so on, a last message output by another party of the conversation session, a message flow of the conversation session. It should be appreciated that there may be two or more parties in the conversation session. In some implementations, the another party of the conversation session is a chatbot. In some implementations, the another party of the conversation session is another user.

In some implementations, at least one next message type are predicted based on at least one of the last message output by the another party and the current conversation session. The one or more candidate queries are predicted based on the at least one next query type and at least one of the last message output by the chatbot and the current conversation session.

In some implementations, the at least one next query type is predicted by using at least one of a universal classifier and a user-specific classifier. The universal classifier is trained by using conversation log data of multiple users such as all users or a large amount of users. The user specific classifier is trained by using conversation log data of a specific user. Therefore the user specific classifier may track the specific user's interest more precisely.

In some implementations, the at least one next query type comprises at least one of an emotional feedback, going deeper to a current topic, going wilder by jumping from current topic to a new topic, and a specific requirement related to the current conversation session.

In some implementations, the one or more candidate second words and/or phrases are predicted based on the first words and/or phrases by using at least one of a universal language model and a user-specific language model. The universal language model is trained by using conversation log data of multiple users such as all users or a large amount of users. The user specific language model is trained by using conversation log data of a specific user. Therefore the user specific classifier may track the specific user's usage habit more precisely.

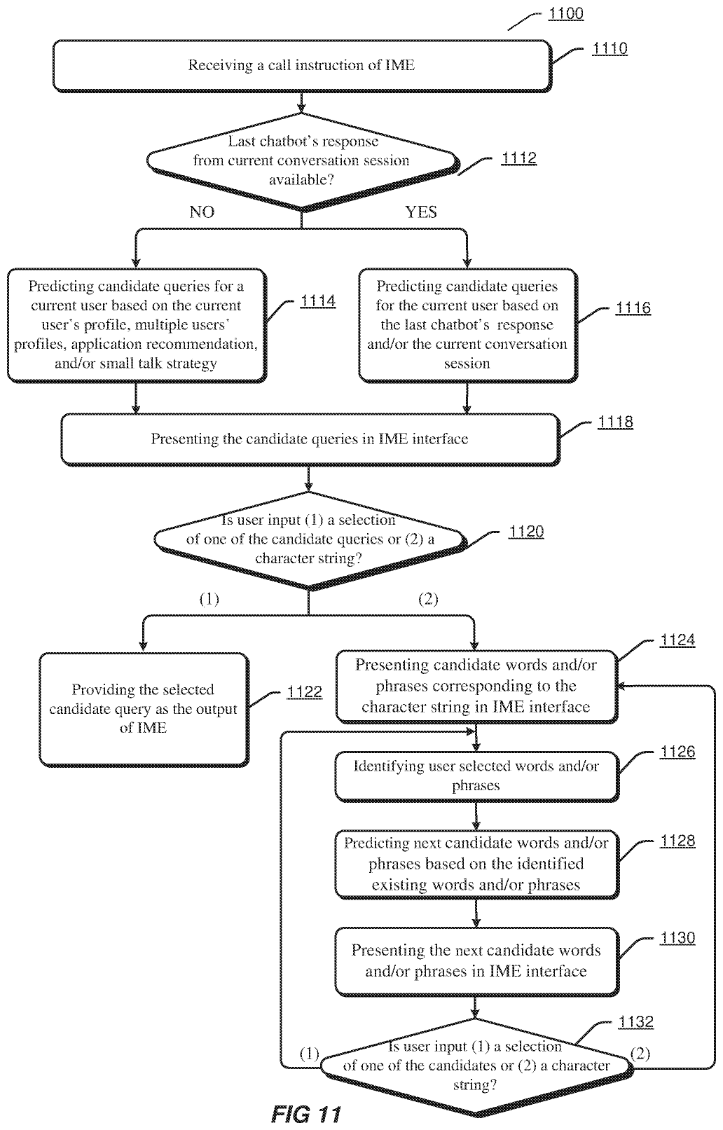

FIG. 13 illustrates an exemplary apparatus 1300 for facilitating information input in a conversation session. The apparatus 1300 comprises a presenting module 1310 configured to present an IME interface during the conversation session, and a providing module 1320 configured to provide one or more candidate messages in the IME interface before a character is input into the IME interface.

In some implementations, the presenting module 1310 is configured to present the IME interface in response to an intention of inputting in the conversation session.

In some implementations, the apparatus 1300 further comprises a receiving module configured to receive a selection of one of the one or more candidate messages. The providing module 1320 is configured to provide the selected candidate message in an input area used for the conversation session.

In some implementations, the providing module 1320 is configured to provide first words and/or phrases based on user inputs, and provide one or more candidate second words and/or phrases in the IME interface based on the first words and/or phrases.

In some implementations, the providing module 1320 is configured to predict the one or more candidate messages based on at least one of a statistical interest of a current user of the IME, a statistical interest of multiple users, an application recommendation information, a small talk strategy, a last message output by another party of the conversation session, a message flow of the conversation session.

In some implementations, the providing module 1320 is configured to predict at least one next message type based on at least one of the last message output by the another party and the current conversation session, and predict the one or more candidate queries based on the at least one next query type and at least one of the last message output by the another party and the current conversation session.

In some implementations, the providing module 1320 is configured to predict the next query type by using at least one of a universal classifier and a specific classifier. In some implementations, the next query type comprises at least user-one of an emotional feedback, going deeper to a current topic, going wilder by jumping from current topic to a new topic, and a specific requirement related to the current conversation session.

In some implementations, the providing module 1320 is configured to predict the one or more candidate second words and/or phrases based on the first words and/or phrases by using at least one of a universal language model and a user-specific language model.

It should be appreciated that the apparatus 1300 may also comprise any other modules configured for performing any operations according to the various embodiments as mentioned above in connection with FIGS. 1-12.

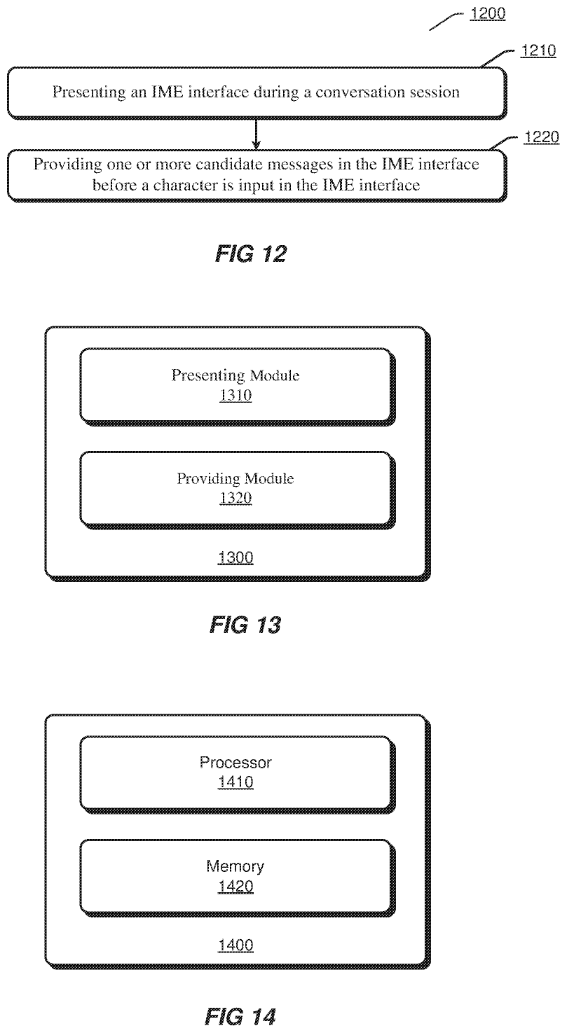

FIG. 14 illustrates an exemplary computing system according to an embodiment.

The system 1400 may comprise one or more processors 1410. The system 1400 may further comprise a memory 1420 that is connected with the one or more processors 1410.

The memory 1420 may store computer-executable instructions that, when executed, cause the one or more processors 1410 to present an IME interface during a conversation session, and provide one or more candidate messages in the IME interface before a character is typed into the IME interface.

It should be appreciated that the computer-executable instructions, when executed, cause the one or more processors 1410 to perform any operations of the processes according to the embodiments as mentioned above in connection with FIGS. 1-13.

The embodiments of the present disclosure may be embodied in a non-transitory computer-readable medium. The non-transitory computer-readable medium may comprise instructions that, when executed, cause one or more processors to perform any operations of the processes according to the embodiments as mentioned above.

It should be appreciated that all the operations in the processes described above are merely exemplary, and the present disclosure is not limited to any operations in the processes or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the disclosure. The functionality of a processor, any portion of a processor, or any combination of processors presented in the present disclosure may be implemented with software being executed by a microprocessor, microcontroller. DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors (e.g., cache or register).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed by the claims.

What is claimed is:

1. A method for facilitating information input in a conversation session, comprising:
presenting an Input Method Editor (IME) interface during the conversation session;
providing one or more candidate messages in the IME interface before a Character is input into the IME interface.

2. The method of claim 1, wherein the presenting an IME interface comprises presenting the IME interface in response to an intention of inputting in the conversation session.

3. The method of claim 2, wherein the intention of inputting is identified in response to an activation of an input area used for the conversation session or in response to a calling of the IME.

4. The method of claim 1, further comprising:
receiving a selection of one of the one or more candidate messages; and
providing the selected candidate message in an input area used for the conversation session.

5. The method of claim 1, further comprising:
providing first words and/or phrases based on user inputs;
providing one or more candidate second words and/or phrases in the IME interface based on the first words and/or phrases.

6. The method of claim 1, further comprising:
predicting the one or more candidate messages based on at least one of a statistical interest of a current user of the IME, a statistical interest of multiple users, an application recommendation information, a small talk strategy, a last message output by another par conversation session, a message flow of the conversation session.

7. The method of claim 6, wherein another party of the conversation session is a chatbot.

8. The method of claim 7, wherein the predicting the one or more candidate messages comprises:
predicting at least one next message type based on at least one of the last message output by the chatbot and the current conversation session; and
predicting the one or more candidate queries based on the at least one next query type and at least one of the last message output by the chatbot and the current conversation session.

9. The method of claim 8, wherein the predicting at least one next query type comprises predicting the at least one next query type by using at least one of a universal classifier and a user-specific classifier.

10. The method of claim 8, wherein the at least one next query type comprises at least one of an emotional feedback, going deeper to a current topic, going wilder by jumping from current topic to a new topic, and a specific requirement related to the current conversation session.

11. The method of claim 5, further comprising:
predicting the one or more candidate second words and/or phrases based on the first words and/or phrases by using at least one of a universal language model and a user-specific language model.

12. An apparatus for facilitating input in a conversation session, comprising:
a presenting module configured to present an Input Method Editor (IME) interface during the conversation session; and
a providing module configured to provide one or more candidate messages in the IME interface before a character is input into the IME interface.

13. The apparatus claim 12, wherein the presenting module is configured to present the IME interface in response to an intention of inputting in the conversation session.

14. The apparatus of claim 12, further comprising:
a receiving module configured to receive a selection of one of one or more candidate messages; and
the providing module is configured to provide the selected candidate message in an input area used for the conversation session.

15. The apparatus of claim 12, wherein:
the providing module is configured to provide first words and/or phrases based an user inputs, and provide one or more candidate second words and/or phrases in the IME interface based on the first words and/or phrases.

16. The apparatus of claim 12, wherein the providing module is configured to predict the one or more candidate messages based on at least one of a statistical interest of a current user of the IME, a statistical interest of multiple users, an application recommendation information, a small talk strategy, a last message output by another party of the conversation session, a message flow of the conversation session.

17. The apparatus of claim 16, wherein the providing module is configured to:
predict at least one next message type based on at least one of the last message output by the another party and the current conversation session; and
predict the one or more candidate queries based on the at least one next query type and at least one of the last message output by the another party and the current conversation session.

18. The apparatus of claim 17, wherein the providing module is configured to predict the next query type by using at least one of a universal classifier and a user-specific classifier.

19. The apparatus of claim 17, wherein the next query type comprises at least one of an emotional feedback, going deeper to a current topic, going wilder by jumping from current topic to a new topic, and a specific requirement related to the current conversation session.

20. A computer system, comprising:
one or more processors; and
a memory storing computer-executable instructions that, when executed, cause the one or more processors to:
present an Input Method Editor (IME) interface during a conversation session; and
provide one or more candidate messages in the IME interface before a character is typed into the IME interface.
